(19) United States
(12) Patent Application Publication
(10) Pub. No.: US 2008/0032255 A1
(43) Pub. Date: Feb. 7, 2008

(54) Method And Apparatus For Monitoring The Structure Of A Tooth

(75) Inventors: Nigel Berry Pitts, Dundee (GB); Christopher Longbottom, Dundee (GB); Przemyslaw Los, Dundee (GB); Marcin Just, Dundee (GB)

Correspondence Address: SUGHRUE MION, PLLC, 2100 PENNSYLVANIA AVENUE, N.W., SUITE 800, WASHINGTON, DC, 20037, US

(73) Assignee: IDMOS, Angus (GB)

(21) Appl. No.: 11/575,687

(22) PCT Filed: Sep. 29, 2005
(86) PCT No.: PCT/GB05/03734

§ 371 Date: May 18, 2007

(30) Foreign Application Priority Data
Oct. 1, 2004 (GB) 0421884.8

(51) Int. Cl. A61C 3/00

(52) U.S. Cl. 433/32; 433/215

(57) ABSTRACT

There is described a method o monitoring the structure of a tooth comprising:—placing an electrode carrier, having at least three electrodes, adjacent the tooth such that the electrodes contact at least one of the occlusal, approximal or free smooth surfaces of the tooth; selecting pairs of the carrier electrodes, one electrode of each selected pair to act as a contact electrode, and the other as a counter electrode; for each selected pair of electrodes, passing an alternating electrical current between the electrodes so as to form a circuit from the electrodes and a respective part of the tooth at least between the electrodes, and monitoring the electrical response for the circuit; and processing the monitored response for each pair of electrodes so as to determine structural information relating to the respective parts of the tooth. Apparatus for carrying out the method is described. The method is preferably an impedance spectroscopy technique, for caries detection and monitoring.

The present invention relates to a method and apparatus for monitoring the structure of a tooth.

As is well established, teeth are extremely specialised structures in animal and human bodies since they require the ability to withstand high levels of stress and abrasion over extended periods of time. These properties are primarily provided by the external white enamel which is extremely hard, and covers the dentine material beneath. At the heart of the tooth, soft tissue in the form of pulp contains blood vessels and nerves. The composition and microstructure of the tooth materials, particularly the enamel, is indicative of the history of the tooth and is an important factor in predicting future behaviour during use, and also may be indicative of certain medical conditions.

The most common problem found in teeth is that of dental caries, which is also know as dental decay, caries or carious lesions. For many years, this has been monitored by probing the teeth with instruments and visual inspection. However, despite its widespread use, this technique is rather inaccurate and often caries may not be detectable visually until a relatively late stage. Caries is most prevalent in the approximal surfaces (those between the teeth) and upon the occlusal (biting) surfaces. Although sometimes present, caries tends to be less common upon the free smooth surfaces which define the remaining surfaces (facing outwardly and inwardly of the mouth). A number of workers, including the present inventors, have been active in researching alternative means by which the structure of teeth can be determined, including structural changes due to caries.

One such approach involves the application of an alternating electrical current to a tooth using a probe or contact electrode. A counter electrode is placed in contact with the body at a distal location and the alternating current is passed between the contact and counter electrodes. The electrical response of the circuit so formed is then measured. Since the tooth itself provides the only significant impedance to the flow of the current, an examination of the response of the circuit formed effectively is that of the behaviour of the electrical current in the tooth.

The international patent application, published as WO97/42909, discusses this technique, including the replacement of the contact electrode with a plurality of such electrodes.

However, it is desirable to further develop the technique so as to provide a more rapid and practical system, and indeed one in which more accurate and useful information may be obtained for use by researchers and indeed practitioners such as dentists.

In accordance with a first aspect of the present invention we provide a method of monitoring the structure of a tooth comprising:—

placing an electrode carrier, having at least three electrodes, adjacent the tooth such that the electrodes contact at least one of the occlusal, approximal or free smooth surfaces of the tooth;

selecting pairs of the carrier electrodes, one electrode of each selected pair to act as a contact electrode, and the other as a counter electrode;

for each selected pair of electrodes, passing an alternating electrical current between the electrodes so as to form a circuit from the electrodes and a respective part of the tooth at least between the electrodes, and monitoring the electrical response for the circuit; and

processing the monitored response for each pair of electrodes so as to determine structural information relating to the respective parts of the tooth.

We have realised that there are significant advantages in the use of an electrode carrier having multiple electrodes, and the use of pairs of these electrodes to apply the alternating current to the respective regions of the tooth. One advantage of this is that an additional and separate counter electrode can be dispensed with entirely, this simplifying the system and accordingly reducing its cost. Furthermore, the use of pairs of electrodes within the electrode carrier allows for the provision of an increased amount of information since electrodes within the carrier can be selected in accordance with their position so as to provide improved information concerning the impedance of the tooth in question.

Typically therefore, the electrode pairs are selected such that no single electrode is common to all of the selected pairs. Any particular electrode may act as a contact electrode in one pair and a counter in another, this allows for greater combinations of electrodes to be used within the same method and therefore increased amounts of information can be obtained. Preferably each electrode forms a pair with each other electrode.

The alternating current is typically applied using a sinusoidal potential although other waveforms, such as a square waveform, triangular waveform and so on are also contemplated. Preferably, the alternating current has a frequency of between 100 Hz and 1 MHz, more preferably 200 Hz to 100 kHz. Lower frequencies tend to be disadvantageous for the health of the host animal or human, whereas higher frequencies tend to provide a lower quality response. Whilst in some applications of the invention the use of a single frequency current is sufficient, in most it is preferable to apply a number of different frequencies of alternating current within the range. Typically this number of frequencies lies in the range 5 to 100.

For each electrode pair, the alternating current at this number of frequencies may be applied in accordance with a predetermined sequence, or alternatively, it may be applied simultaneously. The simultaneous application is advantageous in that it allows for the method as a whole to be performed more rapidly since the time required to apply the number of frequencies in this case is limited in principal only by the lowest frequency in question. In order to improve the accuracy of the monitored measurements, the application of the electrical currents is preferably repeated a number of times for each electrode, such as five times, with a short intervening period between each application.

The electrode carrier for use with the method may take a number of different configurations although typically when the carrier is in position adjacent the tooth, the electrodes adopt a predetermined arrangement with the at least one surface of the tooth. Typically therefore the electrodes are arranged in use at substantially predetermined positions upon the said at least one surface of the tooth. Dependent upon the application, preferably the electrodes contact three, four or all five surfaces of the tooth. Due to the nature of the tooth materials, the electrical responses typically comprise real and imaginary components.

It is particularly preferred that the electrode carrier comprises at least six electrodes and the carrier is arranged such that the electrodes contact at least two surfaces of the tooth. The electrodes in a pair may therefore be simply disposed upon opposed or adjacent differing surfaces. In this way it is possible to calculate the 3-dimensional structure of the tooth. This information may be used for example to determine the extent of dental caries present in the tooth.

Regarding the step of processing the monitored responses, typically this is achieved by inputting the responses as data into a model of the tooth and then calculating the values of impedance for the tooth structure in accordance with the model. The number of calculations that are performed depend upon the complexity of the model used and indeed upon the number of electrode pairs and the number of frequencies of applied current.

Preferably the model of the tooth is a star-like model of impedances corresponding to the electrodes, such that a circuit formed between any pair of electrodes comprises two corresponding impedances in series. This model provides a combination of simplicity for subsequent calculations, and is a good approximation of the physical tooth structure. The impedances in the star-like model take the form of an assumed equivalent circuit. This circuit typically comprises an impedance experienced when the circuit is subjected to high frequency, connected in series with a parallel combination of an impedance at low frequency and a circuit capacitance (or constant phase element).

The high and low frequency impedances may be determined as high and low frequency resistances (the real component of impedance) by analysing the response of each circuit at the number of applied frequencies. This can be achieved using a Z′-Z″ plot.

Using this model, the processing step then comprises forming a matrix of equations representing the resistances between each pair of electrodes for each of the high frequency resistances and low frequency resistances. Each of the corresponding high and low frequency matrices are then solved to provide resistance values for each electrode at high and low frequency. Various methods may be used to achieve this, for example singular value decomposition (SVD).

Having obtained the resistances for each electrode, these may then be related to structural parameters of the tooth since it will be appreciated that the structure of a tooth influences the electrical response. One form of structural information is a quality parameter “T” which can be related to the degree of dental caries present. The parameter T is a numerical representation of the quality of the enamel. High quality enamel has little or no damage due to caries, whereas low quality enamel has a large degree of damage. In this case preferably the processing step further comprises determining the structural information by calculating values of the quality parameter T of the tooth enamel at the electrodes using the calculated resistance values for the electrodes.

Similarly a thickness “d” of the enamel can be calculated. Here the processing step further comprises determining the structural information by calculating values of the thickness d of the tooth enamel at the electrodes using the calculated resistance values for the electrodes. Values of each of T and d can be calculated since these are each related to the resistances at high and low frequency. The low frequency resistance is proportional to T multiplied by d and the high frequency resistance is proportional to d divided by T. This is advantageous clinically since it provides deconvolution of the quality and thickness.

Once the structural information (such as d and/or T) has been determined for the tooth at the electrode positions, it is then preferably calculated for other tooth positions. This can be achieved in a number of ways. One method is to assume a model of the tooth and to assign the values accordingly using an appropriate function, for example by considering possible current flow paths and adding contributions of values from different electrode positions based upon the distance of the electrodes from the location in question. However, preferably a function is used which is based upon an experimental relationship between the resistance values of tooth enamel, the enamel quality and the geometry of the tooth. Such a function can be derived from making measurements upon sliced sections of real teeth. It will be appreciated that the complexity of such a function will influence the accuracy of such calculations.

Having calculated the values at positions other than those of the electrodes, preferably a relaxation method is then applied to the structure values, one or more times.

The calculated values representing the structure are then preferably displayed graphically. Numerous graphical representations are envisaged. It is preferred that, in the case of the quality parameter T, the values of T are represented upon the surface of a three dimensional representation of the tooth. This may be a simple cylinder or a more realistic representation. When the thickness values are displayed these are preferably represented on a three dimensional representation of the tooth having a hollow structure in order for the thickness to be visible. The representation may also be provided with partial transparency to enhance this effect.

It is of course advantageous that the determined structural information relates to the degree of dental caries present in the tooth. It will however be appreciated that there are benefits in determining the physical structure of teeth which do not suffer from caries but nevertheless have a structure influenced by other factors, such as for example in pregnant women. Information about the structure of entirely healthy teeth is of course also advantageous in research and the present invention also finds benefits in this case since it is not necessary to remove or destroy the teeth in order to analyse their structure.

In accordance with a second aspect of the present invention, we provide dental monitoring apparatus for monitoring the structure of a tooth, the apparatus comprising:—

an electrode carrier having at least three electrodes and adapted such that when the carrier is placed adjacent the tooth in use, the electrodes contact at least one of the occlusal, approximal or free smooth surfaces of the tooth;

a control device adapted to perform the functions of:—

selecting pairs of the carrier electrodes, one electrode of each selected pair to act as a contact electrode, and the other as a counter electrode;

pass an alternating electrical current between the electrodes of each selected pair, so as to form a circuit from the electrodes and a respective part of the tooth at least between the electrodes;

monitor the electrical response for the circuit of each selected pair; and

a processing device adapted to monitor the response for each pair of electrodes so as to determine structural information relating to the respective parts of the tooth.

This apparatus may therefore be used to perform the method according to the first aspect of the invention.

Preferably the control device is equipped with an internal power source, the control device being adapted to be connected to the electrode carrier (so as to provide electrical circuit between the control device and the electrodes) and such that the control device is physically isolated from any other devices and/or power sources when the apparatus is in use. This is important for reasons of safety. It allows the apparatus to be less cumbersome and also may serve to reduce any anxiety in human patients caused by the use of an unfamiliar method/apparatus.

Although the apparatus may be a small stand alone unit, preferably the control device at least is a handheld device. Information defining the monitored electrical response is preferably transmitted by electromagnetic radiation between the control and processing devices, this reducing the number of physical wires and also providing for further isolation of the control device. This can be achieved using infra-red or a radio based system such as Bluetooth® In some examples, the control and processing devices are located within a common housing.

Whilst the control device may be used to apply the electrical current at a single frequency, typically it is adapted to apply multi-frequency current to each electrode in a sequence. The currents themselves being applied in a predetermined sequence or simultaneously. The control device therefore typically comprises a signal generator, multiplexer, and analyser to monitor the circuit response. The analyser may be a “lock-in” amplifier, frequency response analyser or fast Fourier transform system.

Preferably the electrode carrier is removably connectable to the control device via a lead. For in vivo measurements, a suitable connector may be used positioned adjacent the mouth of the human or animal in question. Due to hygiene considerations, the electric carrier is preferably a single-use disposable carrier.

A large number of different electrode carrier configurations are envisaged. Many of these comprise a polymeric substrate, this having conductive leads for supplying electrical signals to and from the electrodes. The electrodes are typically metallic and coated in carbon so as to provide electrical contact with the tooth, the carbon providing conductivity and suitable in activity in medical applications.

Whilst the invention described herein is discussed primarily in terms of in vivo measurements, for example in laboratories, veterinary, medical or dental practices, it will be appreciated that the measurements may be performed in vitro also.

Some examples of method and apparatus according to the present invention will now be described, with reference to the accompanying drawings in which:—

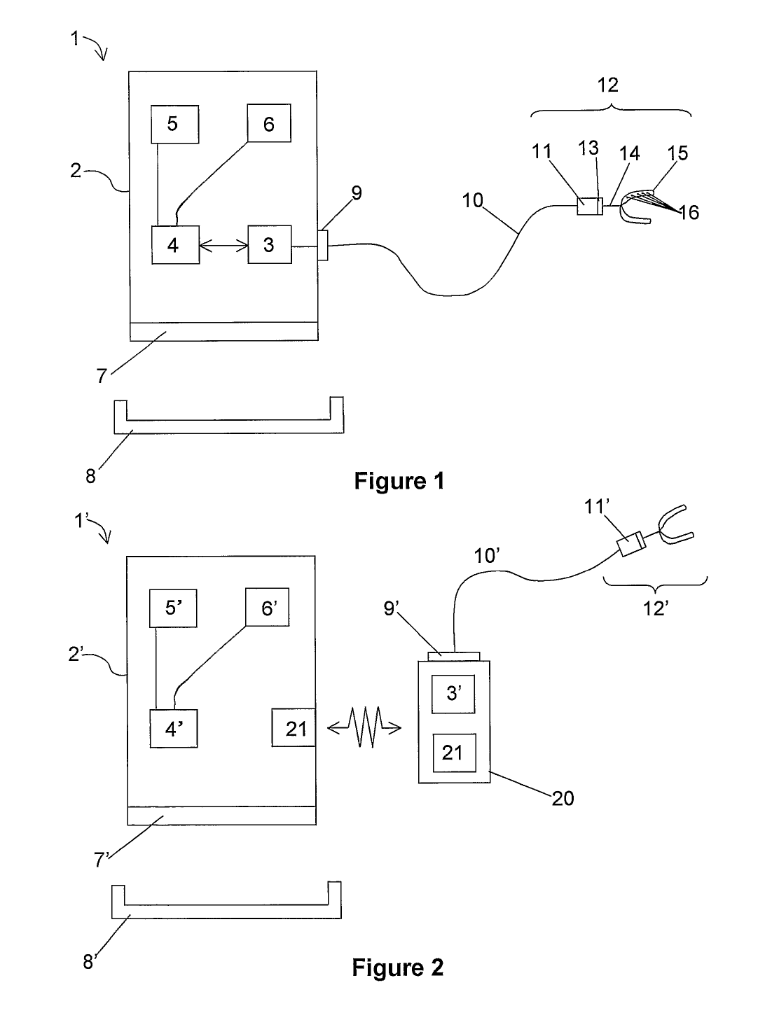

FIG. 1 shows a system according to a first example;

FIG. 2 shows a second example system;

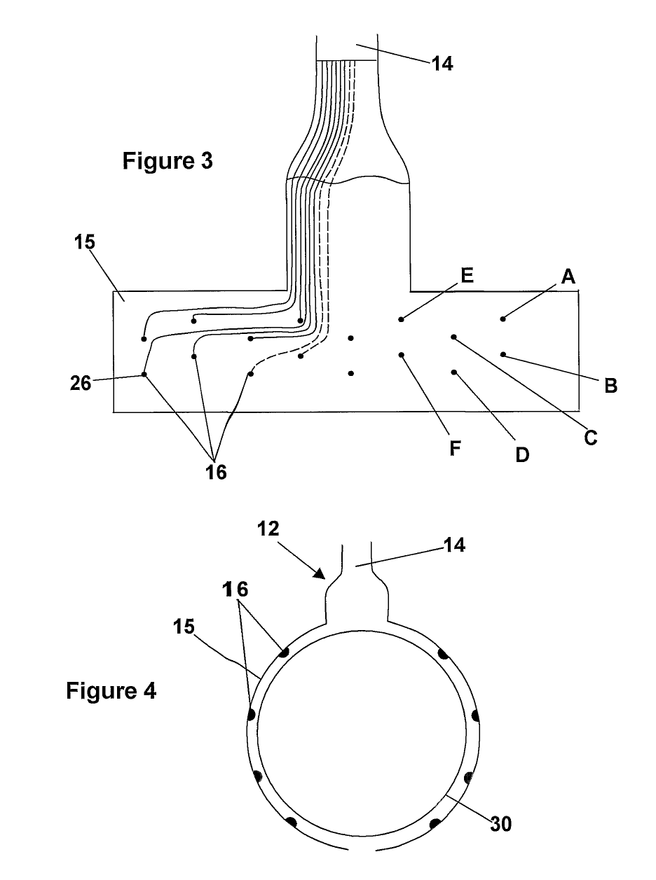

FIG. 3 is an illustration of the electrode arrangement;

FIG. 4 is a schematic view of the electrode carrier assembly positioned around a tooth;

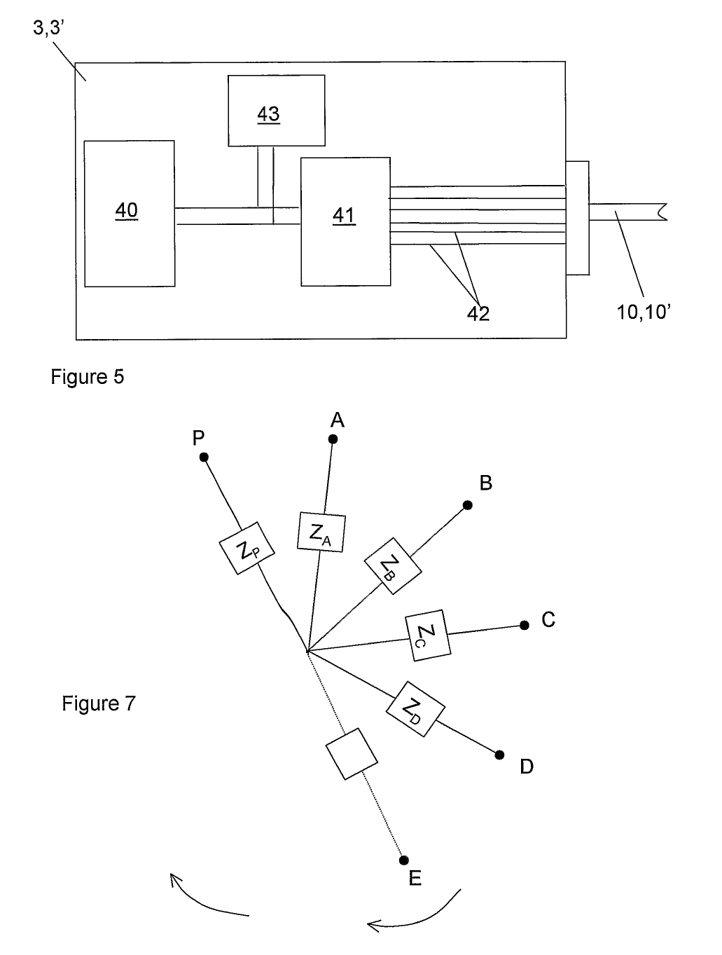

FIG. 5 shows the control unit in more detail;

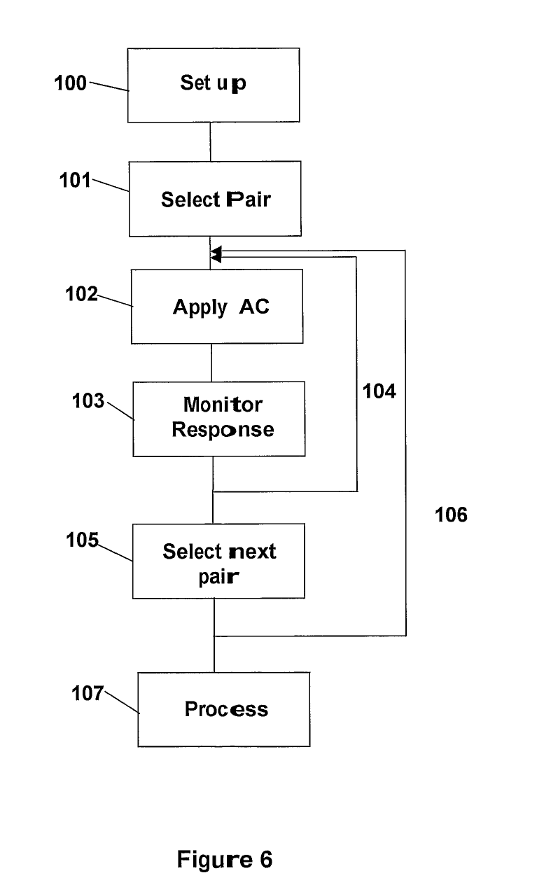

FIG. 6 is a flow diagram of a method of using the systems of the first or second examples;

FIG. 7 shows the assumed electrode impedance model;

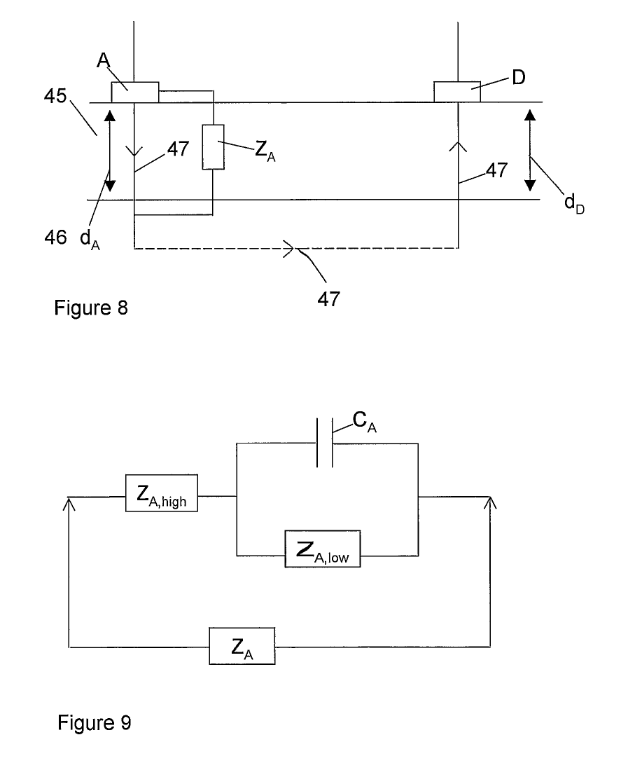

FIG. 8 shows the assumed model of current flow;

FIG. 9 is an assumed impedance equivalent circuit for each electrode;

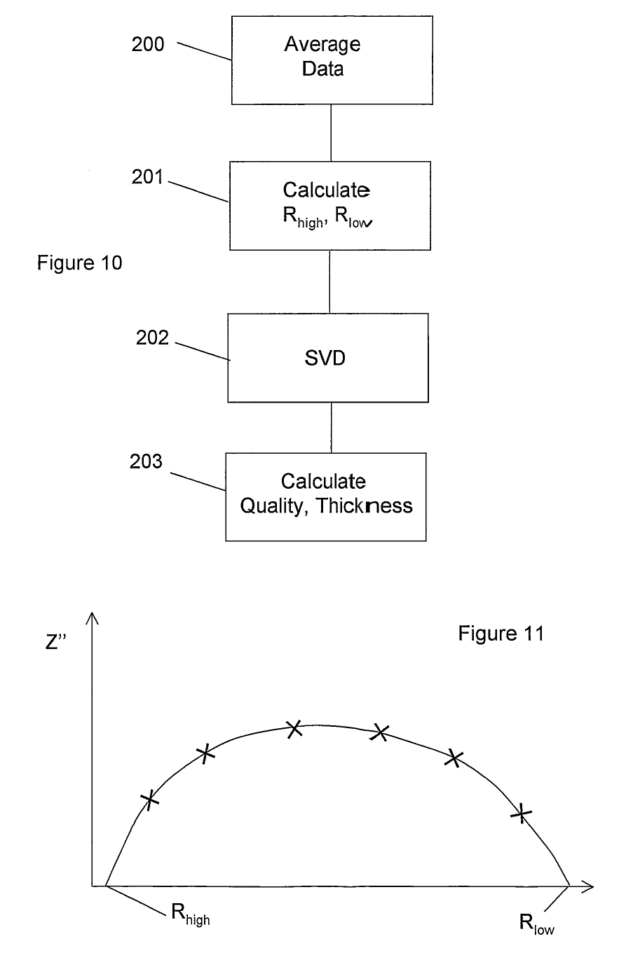

FIG. 10 is a flow diagram showing the calculation of the enamel thickness and a quality parameter;

FIG. 11 shows a schematic Z′-Z″ graph;

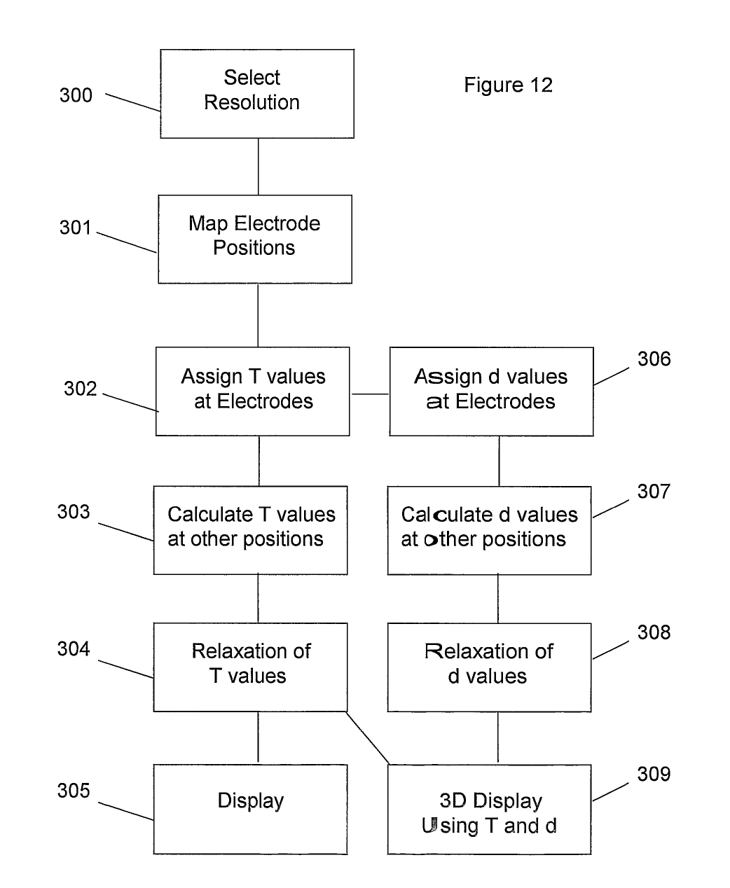

FIG. 12 is a flow diagram showing the conversion of the calculated data into a graphical representation.

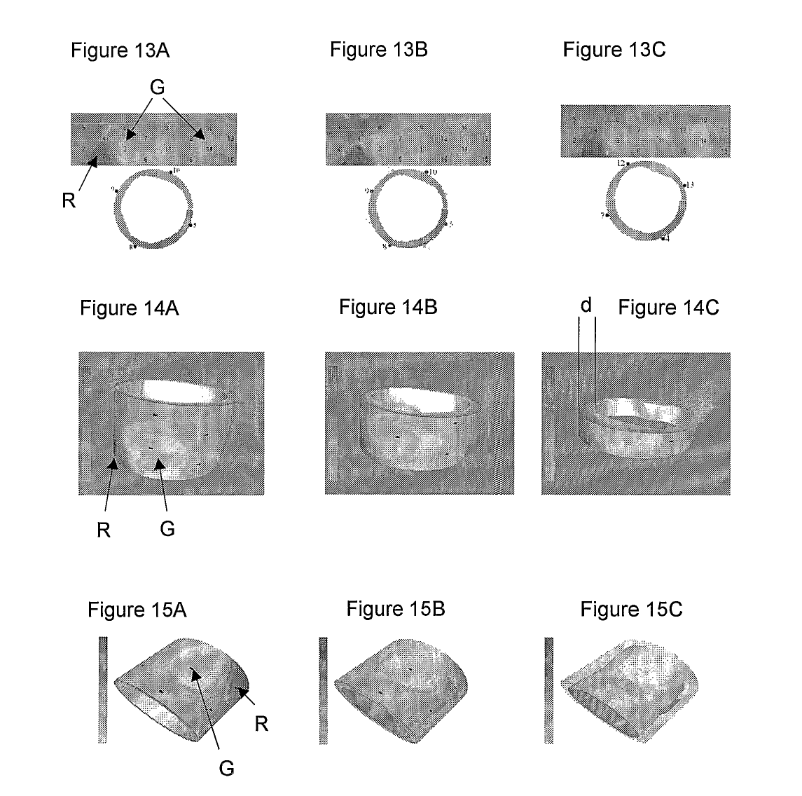

FIG. 13A shows the quality parameter graphical output as a coloured rectangle and a horizontal section through the upper line of electrodes;

FIG. 13B shows the quality parameter graphical output as a coloured rectangle and a horizontal section between two lines of electrodes;

FIG. 13C shows the quality parameter graphical output as a coloured rectangle and a horizontal section taken through a second line of electrodes;

FIG. 14A shows the quality parameter and thickness plotted as a three dimensional cylinder;

FIG. 14B shows part of FIG. 14A; and

FIG. 14C shows a section through the cylinder of FIG. 14A relating to one electrode;

FIG. 15A shows the quality parameter and thickness plotted on a structure having no transparency;

FIG. 15B shows the quality parameter and thickness plotted on a structure having a low transparency;

FIG. 15C shows the quality parameter and thickness plotted on a structure having high transparency; and

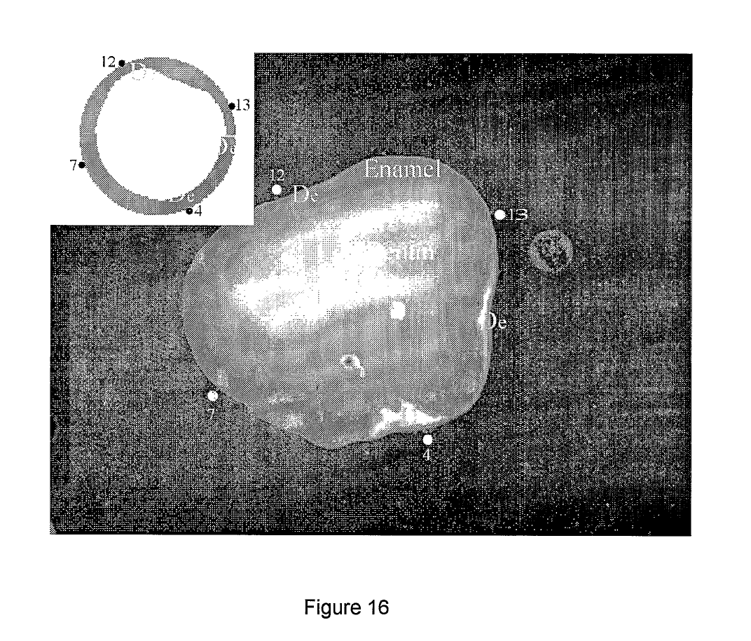

FIG. 16 shows a micrograph and a corresponding calculated region of demineralisation for a tooth.

An example system for monitoring the structure of a tooth is illustrated schematically in FIG. 1 and is generally indicated at 1. The system comprises a portable unit 2 which may be of approximately similar dimensions to a laptop computer. This comprises an internal control device 3 and an internal computer 4. The unit 2 is also fitted with a display screen 5 and input controls such as a keypad 6. The unit 2 is powered by internal rechargeable batteries these being coupled to an inductive receiver 7 such that the unit 2 can be placed upon a corresponding cradle charger 8 so as to provide a simple means of charging the power supply of the unit 2 without the need to physically connect any electrical wires.

The control device is in two-way communication with the computer and is also coupled with a unit connector 9. When in use, a lead 10 is plugged into the connector 9, this lead containing electrical wiring suitable for passing electrical current to and from remote electrodes (to be described below).

At the other, distal end of the lead 10, an electrode carrier connector 11 is provided, this allowing an electrode assembly 12 to be detachably coupled to the lead 10. The electrode assembly 12 has a short portion of wiring 14 to which a plug 13 is attached for coupling to the electrode carrier connector 11. At the other end of the wiring section 14, distal to the plug 13, an electrode carrier 15 is provided, this being arranged to fit adjacent or around the tooth whose structure is to be measured. The electrode carrier 15 comprises a number of electrodes (three or more) 16 for contacting the tooth, each of these being connected to individual wires that are electrically coupled to the control unit 3 via the lead 10 and respective connectors.

FIG. 2 shows an alternative arrangement of the system, this being indicated at 1′. The majority of the components shown in FIG. 2 are similar to those in FIG. 1, these being labelled with primed reference numerals. The main difference between the examples is that the control device 3 in this case, is contained within a separate unit 20 which is adapted to be held in the hand of a human patient whose tooth structure is to be studied. Here, communication between the control device 3 and computer 4 is provided via a shortwave radio link between transmitter/receiver devices 21. Accordingly, the handheld unit 20 is provided with a power supply.

Other examples are envisaged in which at least part of the computer 4 may be also contained within the handheld unit 20. Alternatively the components 2 and 12 or 20 and 12 may be housed in a combination housing with the electrodes extending directly from a more or less rigidly attached connector which contains the electrical connections, rather than having flexible leads 10 and 10. This arrangement bears some similarity to a battery powered toothbrush but has electrical as well as mechanical connection between the handle and the replaceable head. Either unit 2 or 2′ may be further connected to other devices such as personal computers, printers and displays. However, it is important for safety considerations to ensure that, at least during operation in determining the structure of the tooth, either unit 2, 2′ or 9′ is not in physical contact with a mains power supply. Otherwise, if there were a malfunction, this could cause harm to the subject whose tooth is being analysed.

The example system shown in FIG. 2 is particularly beneficial since the handheld unit 20 provides for the apparatus to be less cumbersome in use.

In the following description where reference is made to the components of the first example system of FIG. 1, similar reference is intended to the analogous components of the second example system of FIG. 2, except where a distinction is expressly indicated.

Referring now to FIG. 3, this shows an example electrode carrier 15 taking the general form of a “T” shape (inverted in the figure), the cross member of the “T” having 16 electrodes arranged in an array upon one surface. The electrode carrier 15 is formed from a suitable substrate such as the polyimide sold under the trade name “Kapton” or a similar material which is biologically inert.

As is indicated in FIG. 3, the electrodes 16 are arranged in four lines, these lying in two positions with respect to the “T” cross-member, with pairs of non-adjacent lines being positioned at similar (horizontal) cross-member locations. A number of copper tracks 25 are embedded within the material of the electrode carrier 15 these providing electrical connection to each of the individual electrodes 16. The copper tracks exit the base of the “T” and pass along the wiring section 14 to the connector 13. Corresponding wires within the lead 10 provide electrical connection with the control device 3.

In the present example, each of the electrodes 16 is formed from a small spot of lead-free tin 26, and each is covered by a layer of carbon to provide a biologically inert electrical contact.

FIG. 4 shows a schematic view of a premolar tooth 30 with the occlusal surface lying in a plane parallel to that of the figure. As is indicated, the arms (cross-member) of the “T” are wrapped about the free smooth and approximal surfaces of the premolar tooth 30, such that the electrodes is 16 contact these respective tooth surfaces.

With the electrode assembly 12 in this position, and connected to the remainder of the system 1, the computer 4 is then operated to control the control device 3 so as to pass a series of electrical AC signals (sinusoidal) between various pairs of the electrodes 16. The electrical response of the tooth 30 is measured for each of these electrodes and the results then processed by the computer 4 in order to provide the desired structure determination.

FIG. 5 shows the control device 3 in more detail. The control device comprises a multiple frequency waveform generator 40, this being coupled to a multiplexer 41 which in turn is provided with wiring 42 such that electrical circuits may be formed between any of the electrodes 16 via the lead 10. The multiplexer 41 therefore provides a means of selecting the pairs of electrodes to form a circuit by switching the output of the waveform generator 40 between different wires 42. An analyser 43 is also provided, connected to the multiplexer 41 so as to analyse the response of circuits formed using the wiring 42 and electrodes 16, together with the respective part of the tooth. The analyser 43 may take the form of a lock-in amplifier, frequency response analyser, or fast Fourier transform device (FFT). In the present case a fast Fourier transform device is used since this is the most effective in providing multifrequency monitoring.

A method of operating the apparatus is now described with reference to FIG. 6, this resulting in a structure determination of the tooth that is represented graphically.

At step 100 in FIG. 6, the system is initialized and set up with the subject patient being positioned appropriately and the electrode assembly 12 being connected to the unit 2 (or 20). The electrode carrier 15 is wrapped around the surfaces of the tooth 30, the structure of which is desired to be monitored, with the electrodes 16 each being placed in contact with the respective surfaces of the tooth 30. In the present case of a premolar tooth, the respective surfaces are the two approximal and two free smooth surfaces. The assembly is held in contact with the tooth using a elastomer band. It should be noted that the approximate contact positions between the electrodes and the specific tooth surfaces should either be predetermined or noted during the monitoring (for later input into the calculations), so as to allow the calculated structure to be related to the real tooth structure later on.

The step 100 also includes providing one or more test signals to the electrodes 16 to ensure that the system as a whole is configured correctly and that suitable electrical contact is provided between enough electrodes and the tooth surface. Note that if a particular electrode malfunctions or fails to make electrical contact, then this can be indicated to the operator of the system. The system can nevertheless operate in this instance (provided a sufficient number of electrodes function correctly) and adjustments can then be made in the eventual calculations to allow for the malfunction, although the accuracy of the results in such areas is reduced as a result.

At step 101, an operator of the system (for example a dental practitioner in the case of a human subject or a vet in the case of an animal subject), operates the computer 4 by means of the keypad 6 so as to initiate a monitoring sequence. A start button may alternatively be provided upon the carrier assembly itself, or at the subject end of the lead 10, for ease of operation when the computer 4 may be out of reach. The computer then executes software to operate the control device 3.

At step 101, the software causes the multiplexer 41 to select a first pair of electrodes. With reference to FIG. 3, this first pair of electrodes might be A and B. One of these electrodes can be thought of as the contact electrode, for example A, with the other being the counter electrode, B.

At step 102, a multiple frequency electrical current is supplied to the multiplexer 41 by the waveform generator 40. This is applied via the multiplexer to the circuit formed from the selected wires 42, the corresponding wires in the lead 10, 10′ and the electrodes A and B, together with the respective tooth material between them.

It should be noted that the current takes the form of a multiple frequency signal, these frequencies being applied simultaneously so as to enable the monitoring as a whole to be performed as rapidly as possible. The waveform of each frequency is sinusoidal in the present example. A total of 10 different frequencies are applied, evenly spaced in frequency between 300 Hz and 100 kHz.

The electrical response of the circuit formed (in terms of voltage, current and their respective phase) between the electrodes A and B is then monitored at step 103 by the analyser 43. The response information is stored digitally as output data.

The procedure of steps 102 and 103 is then repeated a further four times so as to provide for a reduction in experimental errors. As a result, 5 overall measurements of the response of the circuit are taken for each pair of electrodes.

Subsequently in step 105, a second pair of electrodes is selected, for example electrodes A and C. Steps 102 to 105 are then performed upon this pair of electrodes. This is repeated at step 106 a number of times until measurements for all combinations of electrodes have been performed. For example, measurements are performed for electrodes A-B, A-C, A-D, A-E . . . , B-C, B-D, B-E . . . C-D, C-E . . . Therefore, for the first electrode there are circuits formed with 15 other electrodes, for the second electrode there are circuits formed with 14 other electrodes, for the third, 13 electrodes and so on. Since each circuit is measured five times, there is no need to perform for example an A-B measurement and then a B-A measurement later, since the circuit is the same.

Having performed the monitoring, five times for each electrode pair, the data are then passed to the computer 4. Note that if the system of FIG. 2 is used, then the data may be transmitted during the end of each measurement for each pair, or they may be stored locally within the unit 20 and then transmitted together afterwards using the transmitter/receiver devices 21.

At step 107 in FIG. 5, the computer 4 processes the information received regarding the voltage and current response, together with their relative phase, for each of the pairs of electrodes.

Having obtained the data relating to the response of the circuit, it is then desired to convert this data into values of electrical impedance which can then be related to the structure of the tooth. In order to do this, it is necessary to assume a model of the components of the tooth. One such model is now described, this being used in the present example.

A star-like connection of impedances is assumed as the model, this being illustrated in FIG. 7. The 16 electrodes (denoted A to P) are considered to be connected electrically to a central hub, each electrode having a corresponding impedance Z_{A} and so on, between the electrode and the hub. Therefore, any connection between two electrodes includes two impedances in series. Taking electrodes A and D as an example, the circuit formed using the electrodes A and D comprises an impedance Z_{A} in series with an impedance Z_{D}.

This can be thought of physically as shown in FIG. 8 where two electrodes A and D are positioned upon the surface of the tooth enamel 45. Beneath the tooth enamel is a dentine layer 46. The assumed current path between electrodes A and D being illustrated at 47. It should be noted that in the dentine layer 46, the impedance is deemed to be negligible with respect to that of the enamel layer 45. The thickness of the enamel underneath each electrode is represented by D_{A} and D_{D} for electrodes A and D respectively. It will be appreciated that the thickness of the enamel, its chemical composition and microstructure influences the impedance at each electrode. The impedance relating to the electrode A is shown in FIG. 8, this being between the electrode and the layer of dentine immediately beneath the enamel layer 45 in the current model.

For each of the impedances Z_{A}, Z_{B} . . . and so on the model assumes that these can be represented using the components shown in FIG. 9 for the example electrode A. Here the impedance Z_{A} is shown as a series combination of the impedance of the circuit at high frequency, Z_{A,High}, in combination with the impedance at low frequency in parallel with a capacitance C_{A}, the low frequency impedance being denoted by Z_{A,low}. It should be noted that this is an assumed model for the purposes of determining the impedance Z_{A}.

FIG. 10 is a flow diagram showing how the model is then used in calculating the structure of the tooth.

At step 200, each of the five sets of data for each pair of electrodes is averaged so as to determine an averaged data set and thereby increase the accuracy of the calculations. The averaged data values are then used in the subsequent processing now described.

The model above has been described in terms of generalized impedances. However, in the present example because a large range of multiple frequencies is used, the real values of impedance, that is “resistance”, can be calculated for each electrode, these being Z_{A,high} and Z_{A.low} for electrode A. In general terms these are a set of values R_{high} and R_{low}. This is performed at step 201 in FIG. 10.

The values of R_{high} and R_{low} are determined from a Z′-Z″ graph as is shown in FIG. 11. For each electrode, the multifrequency responses are plotted on a Z′-Z″ graph, these forming a curve. The curve is then fitted and its intersection with the real (Z′) axis is calculated. The curve actually intersects the real axis at two points, that closest to the origin being equivalent to the resistance at infinite frequency R_{high}, and that furthest from the origin being the resistance at zero frequency R_{low} (which can be thought of as DC current). The form of the curve, together with the impedance values is a function of the tooth structure, particularly the enamel thickness and structure. Note that assumptions of low dielectric loss and lack of dispersion are made.

The result of the calculating step 201 is a series of resistance values R_{high} for infinite frequency and resistance values R_{low} for zero frequency corresponding to the circuits formed between the various pairs of electrodes. However, each value R_{high} or R_{low} comprises component resistances due to the model illustrated earlier with reference to FIG. 9. Therefore:—
R_{AD,high}=R_{A,high}+R_{D,high}
R_{AD,low}=R_{A,low}+R_{D,low}

R_{AD,high} is therefore the total resistance of the circuit between the electrodes A and D, this being the summation of resistances of the electrodes A and D individually since these are in series in the assumed circuit model of FIG. 8. This also applies for the low frequency resistances, R_{AD,low}.

A large number of high frequency resistance values and low frequency resistance values are therefore determined, due to the large number of circuits formed from combinations of the electrodes.

In step 202, two independent matrices are formed using the high frequency and low frequency data respectively for the different electrode circuits. An example is indicated below in Table 1. Table 1 shows a data matrix format for the AC impedance results using 16 electrodes probe. Each value represents resistance measured between electrodes numbered from 1 to 16. “−1” means no value is given.

TABLE 1
; 1; 2; 3; 4; 5; 6; 7; 8; 9; 10; 11; 12; 13; 14; 15; 16
1; −1; −1; −1; −1; −1; −1; −1; −1; −1; −1; −1; −1; −1; −1; −1; −1
2; 263.3; −1; −1; −1; −1; −1; −1; −1; −1; −1; −1; −1; −1; −1; −1; −1
3; 336; 200.2; −1; −1; −1; −1; −1; −1; −1; −1; −1; −1; −1; −1; −1; −1
4; 354; 283.5; 147.8; −1; −1; −1; −1; −1; −1; −1; −1; −1; −1; −1; −1; −1
5; 688; 589; 428; 366; −1; −1; −1; −1; −1; −1; −1; −1; −1; −1; −1; −1
6; 286.8; 320; 193.2; 284.2; 430; −1; −1; −1; −1; −1; −1; −1; −1; −1; −1; −1
7; 425; 501; 287.4; 600; 860; 232.5; −1; −1; −1; −1; −1; −1; −1; −1; −1; −1
8; 508; 637; 532; 753; 1016; 388; 325; −1; −1; −1; −1; −1; −1; −1; −1; −1
9; 504; 634; 570; 817; 1239; 457; 460; 364; −1; −1; −1; −1; −1; −1; −1; −1
10; 314.9; 478; 506; 832; 1172; 481; 498; 444; 277.5; −1; −1; −1; −1; −1; −1; −1
11; 247.5; 534; 452; 768; 1216; 466; 486; 473; 374; 108.6; −1; −1; −1; −1; −1; −1
12; 588; 639; 653; 1049; 1484; 694; 669; 694; 600; 304.5; 189; −1; −1; −1; −1; −1
13; 533; 647; 586; 978; 1461; 641; 697; 778; 647; 330; 231.7; 199.9; −1; −1; −1; −1
14; 441; 377; 474; 785; 1323; 474; 589; 705; 498; 210.4; 164; 182.6; 144.8; −1; −1; −1
15; 363; 419; 395; 463; 1273; 477; 473; 639; 478; 154.4; 115.6; 197.6; 140.9; 88.3; −1; −1
16; 392; 120.1; 216.3; 589; 1170; 275.7; 353; 568; 465; 85.9; 23.97; 161; 118.2; 56.1; 68.2; −1

The data of Table 1 therefore represents a series of simultaneous equations, from which the values of the type R_{A,high} and R_{A,low} require calculation for each electrode. Singular Value Decomposition (SVD) analysis is therefore performed upon the two respective matrices at step 202 in FIG. 11, in order to determine the low and high frequency resistances according to each specific electrode.

It has been found that the “quality” of the enamel of the tooth can be represented by a generic term T, this being a tissue (enamel) parameter. Higher values of T represent high quality enamel, whereas low values represent damaged enamel (such as due to dental caries).

The low frequency resistance is proportional to the tissue parameter T multiplied by the thickness of the enamel d at the electrode, whereas the high frequency resistance is proportional to the thickness of the enamel d divided by the tissue parameter T. This can therefore be represented, for an example electrode A, as:—
R_{A,low}αT·d_{A}
R_{A,high}αd_{A}/T

Using the above equations, in step 203, the high and low resistance data are then converted into a corresponding value for T and thickness d of the enamel under each specific electrode.

Having determined these values, a representation of the structure of the tooth enamel can then be presented. This is performed graphically in the present example.

FIG. 12 shows the method by which the data obtained according to FIG. 10 is displayed graphically, for example using a display 5 attached to the computer 4.

At step 300 in the method, a choice of calculation resolution is made and this may be dependent upon the number of electrodes used in the analysis. In the present example a rectangle is used to represent the connected surfaces of the tooth that were contacted by the electrodes. The rectangle in this example is divided into 200 points along its length and 100 points along its width. The 200 points represent points upon the approximal and free smooth surfaces (four in total), with the 100 points representing the height of the tooth on each of these surfaces. This choice of resolution results in 20000 locations upon the rectangle.

At step 301, the positions of the electrodes are related to the rectangle geometry. Since the electrodes in the present example were spaced in four rows of four electrodes, these are then transferred to corresponding locations upon the rectangle. The rectangle is ultimately related to the tooth geometry and it is therefore important to understand which points of the rectangle correspond to those upon the tooth so that localized areas of the structure can be identified and related to the actual tooth. In the present example the relative orientation of the electrodes with respect to particular tooth surfaces is known due to the manner in which the assembly was initially positioned in use.

At step 302, the values of the tissue parameter T are attributed to each of the electrode positions on the rectangle. It should be noted that these values are fixed since they represent calculations as a result of monitoring.

At step 303, T values are assigned for each of the other 19984 (20000 minus 16) points on the rectangle. These T values are calculated using an empirical function. The empirical function is derived off-line by slicing thin sections of teeth upon which impedance measurements have been taken, and relating the impedance values to the quality of the enamel which can be determined microscopically. A similar analysis can be performed for the enamel thickness that is described later. It will be appreciated that a number of different functions can be used for this purpose, these being derived by experimentation, modelling, or a combination of each of these.

Once assigned values of the enamel quality have been made for each of the points in the rectangle, in step 304, a “relaxation” procedure is performed so as to provide smooth transitions between the values of T. This means that, for all T values in the rectangle other than the 16 monitored values, the T value in question is replaced by the average of the adjacent T values. This procedure is performed repeatedly in step 304 until a predetermined smoothness in the values has been achieved.

At step 305 the data are then plotted graphically on a display, with colours being assigned to the various quality values of T. For example the highest quality values of T may be assigned a vivid green colour, with the lowest quality values being assigned a vivid red colour and all intermediate values being assigned according to a spectrum between these two extremes.

The representation of the quality of the enamel may be presented in the form of a flat two-dimensional rectangle, for example showing the positions of the electrodes, or alternatively as a rotatable surface of a cylinder, which may then be rotated by a user of the computer 4. The positions of the electrodes upon the actual tooth surfaces should be identified so that the user is able to determine which parts of the enamel on the real tooth relate to the calculated values on the rectangle.

FIGS. 13A to C show an example graphical output. In each of FIGS. 13A to C the rectangle mentioned above is illustrated, coloured according to the T values from red to green. The red areas indicate low quality enamel whereas the green areas show high quality enamel. A typical red area is marked with a R and a typical green area with a G, the darker shades indicating colours close to the red end of the quality spectrum. Underneath each of the rectangles in FIGS. 13A to C is illustrated a (horizontal) section through the tooth, this being taken alone a horizontal line through the rectangle and then translated as a circle. In FIG. 13A, the section is taken through the electrodes 5, 8, 9 and 10 (in the upper part of the rectangle). Similarly in FIG. 13C, the section is taken through on a line through the electrodes 4, 7, 12 and 13. In FIG. 13B, the line is taken at a line which is equal in distance between the electrodes of FIGS. 13A and 13C.

It will be recalled from earlier, that the thickness of the enamel under each electrode was calculated, in addition to the quality factor T, since each of these was one unknown in the equations containing monitored values for the high frequency and low frequency resistances.

Therefore a similar method as was described for the T calculations can be used to calculate the thickness of the enamel at the points which are not directly underneath the electrodes. Referring once more to FIG. 12, the right hand side of the Figure illustrates the additional steps 306 to 308. At step 306, the “d” values are plotted on the rectangle at the positions of the electrodes. At step 307 “d” values are calculated for all other points in the rectangle. Information from real sliced sections of tooth enamel can be used to derive an empirical function which allows these d values to be calculated. A theoretical model or a combination of these techniques can also be used here, as for the thickness parameter T.

Relaxation of the values is again performed at step 308 in a similar manner to those at step 304 and at step 309 an alternative three-dimensional graphical output is presented. This represents the combination of the information relating to the enamel quality, with that relating to the thickness. This is shown in FIG. 14A to C, where the data relating to the quality and thickness of the enamel are plotted, the quality data being presented as colours in a similar manner as before, although this time this is plotted on the surface of a three-dimensional structure (approximately cylindrical) with the localized thickness of the wall of the structure being according to the calculated thickness values d. This is shown in FIGS. 14A to 14C, with different sections of the enamel illustrated, and electrode positions marked with dots.

In order to illustrate the thickness data more clearly, a certain degree of transparency of the three dimensional structure can be used. FIG. 15A for example shows no transparency, whereas FIG. 15B shows a low level of transparency and FIG. 15C a high level of transparency. The colours remain plotted on the outer surfaces in each case. The darker shades once more represent quality values closer to the red end of the spectrum.

There are many ways in which the data of quality and/or thickness of the enamel can be plotted and those described herein are examples. Of course the choice of colours is somewhat arbitrary although those described above are advantageous since they provide little possibility of confusion.

Whilst a cylinder provides a convenient approximate representation of a tooth, it is also considered within the scope of the invention that a three-dimensional tooth structure could be used in the graphical representation, with the relative thicknesses of the structure being controlled according to the calculated values. The quality of the enamel could then be simply plotted by the use of bitmap techniques.

As an illustration of the effectiveness of the invention, FIG. 16 shows the structure of a section of tooth determined as a result of the calculations described above. This is inset in a micrograph of the tooth. In each case the respective electrode positions are marked and areas labelled “De” denote regions of demineralisation of the tooth, which is indicative of dental caries. This illustrates that the method provides a determination of structure which accurately represents reality.

As a further example, a simplified method with respect to that above, is now described. Here similar apparatus is used as described with reference to FIG. 1 or 2 earlier. In this basic example, three electrodes 16 are provided upon the carrier 15, these each having a similar contact area as earlier. Note that assumptions can be made if necessary with regard to the effect upon impedance values of electrodes having different contact areas. This is not required in the present example.

Of the three electrodes, a first electrode “1” may be thought of as a working or contact electrode, and it is desired here to obtain the impedance of the enamel under the first electrode. Second and third electrodes are also provided in this case making up the three electrodes of the system. The second and third electrodes are arranged in close proximity to one another on the surface of the tooth in question, such that it can be fairly assumed that the enamel they contact has a similar impedance in each case.

The system is then operated to determine the electrical response of the circuit formed by:—

a) Electrodes 1 and 2 or Electrodes 1 and 3, that is Z₁₂=Z₁+Z₂ for example; and

b) Electrodes 2 and 3, that is Z₂₃=Z₂+Z₃.

Again the star-shaped impedance model of FIG. 7 is assumed here.

Since electrodes 2 and 3 are assumed to have the same impedance, the impedance associated with the working electrode 1 (Z₁) can be determined (from the above) by the equation Z₁=Z₁₂−(Z₂₃/2)

Note that if a single frequency measurement is used to determine the value of Z₁ then this, when combined with some of the techniques described earlier, will provide information regarding the extent of caries in the tooth at the location of the electrode 1. With a multifrequency measurement, the extent of caries and the thickness of the enamel can be determined.

Either case therefore provides the desired value for Z₁. It will be appreciated that this example can therefore be expanded to determine impedance values, and therefore structure determination, for a number of electrodes on one or more tooth surfaces. This may include the use of other electrodes such as electrodes 2 and 3, as working electrodes and/or counter electrodes.

contact with the body at a distal location and the alternating current is passed between the contact and counter electrodes. The electrical response of the circuit so formed is then measured. Since the tooth itself provides the only significant impedance to the flow of the current, an examination of the response of the circuit formed effectively is that of the behaviour of the electrical current in the tooth.

The international patent application, published as WO97/42909, discusses this technique, including the replacement of the contact electrode with a plurality of such electrodes.

However, it is desirable to further develop the technique so as to provide a more rapid and practical system, and indeed one in which more accurate and useful information may be obtained for use by researchers and indeed practitioners such as dentists.

In accordance with a first aspect of the present invention we provide a method of monitoring the structure of a tooth comprising:—

placing an electrode carrier, having at least three electrodes, adjacent the tooth such that the electrodes contact at least one of the occlusal, approximal or free smooth surfaces of the tooth;

selecting pairs of the carrier electrodes, one electrode of each selected pair to act as a contact electrode, and the other as a counter electrode;

for each selected pair of electrodes, passing an alternating electrical current between the electrodes so as to form a circuit from the electrodes and a respective part of the tooth at least between the electrodes, and monitoring the electrical response for the circuit; and

processing the monitored response for each pair of electrodes so as to determine structural information relating to the respective parts of the tooth.

We have realised that there are significant advantages in the use of an electrode carrier having multiple

1. A method of monitoring the structure of a tooth comprising:—
placing an electrode carrier, having at least three electrodes, adjacent the tooth such that the electrodes contact at least one of the occlusal, approximal or free smooth surfaces of the tooth;
selecting pairs of the carrier electrodes, one electrode of each selected pair to act as a contact electrode, and the other as a counter electrode;
for each selected pair of electrodes, passing an alternating electrical current between the electrodes so as to form a circuit from the electrodes and a respective part of the tooth at least between the electrodes, the alternating current for each pair being applied at a number of different frequencies in the range 100 Hz to 1 MHz, and monitoring the electrical response for the circuit; and
processing the monitored response for each pair of electrodes so as to determine structural information relating to the respective parts of the tooth.

2. A method according to claim 1, wherein the electrode pairs are selected such that no electrode is common to all of the selected pairs.

3. A method according to claim 2, wherein each electrode forms a pair with each other electrode.

4. A method according to claim 1, wherein the electrode carrier comprises at least 6 electrodes and wherein the carrier is arranged such that the electrodes contact at least two surfaces of the tooth.

5. A method according to claim 4, wherein the selected pairs of electrodes include pairs in which the two electrodes are upon different surfaces of the tooth.

6. A method according to claim 1, wherein for each pair, the application of the electrical current is repeated a number of times.

7. A method according to claim 1, wherein the electrodes of the carrier have a predetermined arrangement when in contact with the at least one surface of the tooth.

8. A method according to claim 1, wherein the electrodes are arranged in use at substantially predetermined positions upon the at least one surface of the tooth.

9. A method according to claim 1, wherein the electrical responses comprise real and imaginary components.

10. A method according to claim 1, wherein the electrodes contact 3, 4 or 5 surfaces of the tooth.

11. A method according to claim 1, wherein the frequency is in the range 200 Hz to 100 kHz.

12. A method according to claim 1, wherein the number of frequencies applied is in the range 5 to 100.

13. A method according to claim 1, wherein the method further comprises, for each electrode pair, applying an alternating current at a number of frequencies in accordance with a predetermined sequence.

14. A method according to claim 1, wherein the number of frequencies are applied simultaneously.

15. A method according to claim 1, wherein the step of processing the monitored responses comprises:—
inputting the responses as data into a predetermined model of the tooth; and
calculating values of the impedance for each electrode in accordance with the model.

16. A method according to claim 15, wherein the model of the tooth is a star-like model of impedances corresponding to the electrodes, such that a circuit formed between any pair of electrodes comprises two corresponding impedances in series.

17. A method according to claim 16, wherein the impedances in the star-like model are assumed impedance at high frequency, connected in series with a parallel combination of an impedance at low frequency and a capacitance.

18. A method according to claim 17, wherein the high and low frequency impedances are determined as high and low frequency resistances by analysing the response of each circuit at the number of applied frequencies.

19. A method according to claim 17, wherein the processing step comprises forming a matrix of equations representing the resistances between each pair of electrodes for each of the high frequency resistances and low frequency resistances.

20. A method according to claim 19, wherein the processing step further comprises solving the high and low frequency matrices to provide resistance values for each electrode at high and low frequency.

21. A method according to claim 20, wherein the matrices are solved using singular value decomposition.

22. A method according to claim 15, wherein the processing step further comprises determining the structural information by calculating values of a quality parameter T of the tooth enamel at the electrodes using the calculated resistance values for the electrodes.

23. A method according to claim 15, wherein the processing step further comprises determining the structural information by calculating values of the thickness d of the tooth enamel at the electrodes using the calculated resistance values for the electrodes.

24. A method according to claim 22, wherein the low frequency resistance is proportional to T multiplied by d and wherein the high frequency resistance is proportional to d divided by T.

25. A method according to claim 1, further comprising determining the structural information for parts of the tooth other than at the electrode positions.

26. A method according to claim 25, wherein the structural information at parts of the tooth other than at the electrodes is determined using a function describing the tooth structure, the function being based upon modelling and/or experimental measurement upon real teeth.

27. A method according to claim 25, further comprising applying a relaxation method one or more times to the calculated values.

28. A method according to claim 1, further comprising displaying the determined structural information graphically.

29. A method according to claim 28, wherein the values of T are represented upon the surface of a three dimensional representation of the tooth.

30. A method according to claim 28, wherein the values of d are represented on a three dimensional representation of the tooth.

31. A method according to claim 30, wherein the representation is provided with partial transparency.

32. A method according to claim 1, wherein the determined structural information relates to the degree of dental caries present in the tooth.

33. A method according to claim 1, wherein at least one pair of electrodes is placed in relative close proximity on the surface of the tooth, wherein the impedance of the tooth with respect to each electrode of the said pair is assumed to be equal, such that the said impedance for each electrode can be determined directly from the electrical response of the respective circuit, and wherein the said determined impedance is used to calculate the impedance for at least one further electrode.

34. Dental monitoring apparatus for monitoring the structure of a tooth, the apparatus comprising:—
an electrode carrier having at least three electrodes and adapted such that when the carrier is placed adjacent the tooth in use, the electrodes contact at least one of the occlusal, approximal or free smooth surfaces of the tooth;
a control device adapted to perform the functions of:—
selecting pairs of the carrier electrodes, one electrode of each selected pair to act as a contact electrode, and the other as a counter electrode;
pass an alternating electrical current between the electrodes of each selected pair, so as to form a circuit from the electrodes and a respective part of the tooth at least between the electrodes, the alternating current for each pair being applied at a number of different frequencies in the range 100 Hz to 1 MHz;
monitor the electrical response for the circuit of each selected pair; and
a processing device adapted to monitor the response for each pair of electrodes so as to determine structural information relating to the respective parts of the tooth.

35. Apparatus according to claim 34, wherein the control device has an internal power source and is adapted to be connected to the electrode carrier such that the control device is physically isolated from other devices and/or power sources when in use.

36. Apparatus according to claim 35, wherein the control device is a handheld device.

37. Apparatus according to claim 34, wherein information defining the monitored electrical response is transmitted by electromagnetic radiation between the control and processing devices.

38. Apparatus according to claim 34, wherein the control and processing devices are positioned within a common housing.

39. Apparatus according to claim 34, wherein the control device is adapted to apply the electrical current at a number of frequencies either in a predetermined sequence or simultaneously.

40. Apparatus according to claim 34, wherein the control device comprises a signal generator, multiplexer, and a device for analysing the response of the circuits.

41. Apparatus according to claim 34, wherein the electrode carrier is removably connectable to the control device via a lead.

42. Apparatus according to claim 34, wherein the electrode carrier is a single-use disposable carrier.

43. Apparatus according to claim 34, wherein the electrode carrier comprises a polymeric substrate, conductive wires for supplying electrical signals to and from the electrodes, and metallic electrodes coated in carbon for providing electrical contact with the tooth.

44. Apparatus according to claim 34, wherein the contact area with the tooth of each electrode is substantially the same.
